(19) United States
(12) Patent Application Publication
(10) Pub. No.: US 2024/0145854 A1
(43) Pub. Date: May 2, 2024

(54) Cover for a battery module or for a battery store

(71) Applicant: ElringKlinger AG, Dettingen (DE)

(72) Inventors: Florian Schwarz, Reutlingen (DE); Matthias Eilers-Rethwisch, Reutlingen (DE)

(21) Appl. No.: 18/409,396

(22) Filed: Jan. 10, 2024

Related U.S. Application Data
(63) Continuation of application No. PCT/EP2022/069301, filed on Jul. 11, 2022.

(30) Foreign Application Priority Data
Jul. 13, 2021 (DE) 10 2021 118 068.6

(51) Int. Cl. H01M 50/367; H01M 50/213; H01M 50/271; H01M 50/383

(52) U.S. Cl. CPC H01M 50/367; H01M 50/213; H01M 50/271; H01M 50/383

(57) ABSTRACT

In order to create a cover for a battery module or for a battery store that comprises a plurality of battery cells, said cover serving not only as contact protection or as protection from the ingress of particles, but also fulfilling the function of a propagation protection by means of which a propagation of a thermal fault from one battery cell of the battery module or the battery store to other battery cells of the battery module or the battery store is able to be prevented or at least delayed, it is proposed that the cover comprises a first layer facing toward the battery cells in the mounted state of the cover and a second layer facing away from the battery cells in the mounted state of the cover, wherein the first layer comprises at least one penetration device, which enables a passage of hot gas from a battery cell through the first layer at a penetration point, and wherein the gas that has passed through the first layer is able to be dissipated from the penetration point in an interspace between the first layer and the second layer.

### RELATED APPLICATIONS

This application is a continuation of international application number PCT/EP2022/069301 filed on 11 Jul. 2022 and claims the benefit of German application number 10 2021 118 068.6 filed on 13 Jul. 2021.

The present disclosure relates to the subject matter disclosed in international application number PCT/EP2022/069301 of 11 Jul. 2022 and German application number 10 2021 118 068.6 of 13 Jul. 2021, which are incorporated herein by reference in their entirety and for all purposes.

### FIELD OF THE DISCLOSURE

The present invention relates to a cover for a battery module or for a battery store that comprises a plurality of battery cells.

Known covers of such battery modules are produced in one layer from a plastic material and have the function of contact protection and protection from the ingress of potentially harmful particles.

It has already been proposed to replace such plastic covers for battery modules with steel covers that have an additional electrical insulation. However, this leads to an increase in the total weight and production costs of the battery module, which is undesirable.

In accordance with an embodiment of the invention, a cover for a battery module or for a battery store of the kind stated at the outset is created, which serves not only as contact protection or a protection from the ingress of particles, but also fulfills the function of a propagation protection, by means of which a propagation of a thermal fault from one battery cell of the battery module or the battery store to other battery cells of the battery module or the battery store is able to be prevented or at least delayed.

### SUMMARY OF THE INVENTION

In accordance with an embodiment of the invention, in the case of a cover for a battery module or a for battery store according to the preamble of claim 1, provision is made that the cover comprises a first layer facing toward the battery cells in the mounted state of the cover and a second layer facing away from the battery cells in the mounted state of the cover,
wherein the first layer comprises at least one penetration device, which enables a passage of hot gas from a battery cell through the first layer at a penetration point, and
wherein the gas that has passed through the first layer is able to be diverted from the penetration point in an interspace between the first layer and the second layer.

Underlying the invention is the concept that in the case of a thermal fault, the first layer of the cover is penetrated at a point (at the penetration point) by the pressure of the hot gases exiting the degassing opening when a defective battery cell is degassed and the hot gases and, as the case may be, flames and particles enter the interspace between the first layer and the second layer of the cover. As a result of the penetration of the first layer of the cover at a point, other battery cells are protected from a blowback of the hot gases or, as the case may be, flames and particles, whereby a propagation of the thermal fault to other battery cells of the battery module or the battery store, in particular to battery cells directly adjacent to the defective battery cell, is able to be prevented or at least delayed.

Furthermore, the escaping hot gas can be conducted or guided in a direction in a targeted manner in order to be able to more quickly transport the gas out of the module or store housing.

Provision is preferably made that the second layer of the cover is impenetrable to hot gas that passes through the first layer of the cover at the penetration point.

The material that is used for the formation of the first layer and/or the second layer of the cover preferably has such a high thermal barrier that a channeling of the hot gases and, as the case may be, flames that arise in the case of a thermal fault is able to take place in the interspace between the first layer and the second layer of the cover.

Furthermore, the material used for the formation of the first layer and/or the second layer of the cover is preferably light, cost-effective, and/or easy to shape.

The material used for the formation of the first layer and/or for the formation of the second layer of the cover is preferably a high temperature resistant material.

In this description and the appended claims, a high temperature resistant material is understood to be a material that passes the Bunsen burner test described in the following.

In the Bunsen burner test, a planar plate of the material to be tested is subjected to the flame of a Bunsen burner, the outlet opening of which is at a distance of 4.0 cm from the surface of the plate facing toward the Bunsen burner. The plate of the material to be tested is hereby oriented such that its normal direction coincides with the blast axis of the Bunsen burner.

If the material to be tested is not penetrated by the Bunsen burner flame during a period of 60 seconds after ignition of the Bunsen burner, the material to be tested is considered to be high temperature resistant.

The Bunsen burner is operated with propane gas for the Bunsen burner test.

The temperature reached at the top side of the plate of the material to be tested that faces toward the Bunsen burner during the Bunsen burner test is at least 1,500° C.

Alternatively to a high temperature resistant material according to the Bunsen burner test, the first layer and/or the second layer of the cover may comprise a material that passes the “Rapid Rise Fire Test” according to the standard UL 1709 in the version published on 24 Feb. 2017 for a protection duration of 240 minutes. This standard has been developed by the organization Underwriters Laboratories, USA.

Provision may further be made that the first layer and/or the second layer of the cover comprises a material that passes the “Jet Fire Protection Test” according to the standard OTI 95 634 in the version of 1996 for a protection duration of 120 minutes. This standard was developed by the organization “The Jet Fire Test Working Group” for the “Health and Safety Executive”.

In a preferred embodiment of the invention, provision is made that the first layer and/or the second layer of the cover comprise(s) a high temperature resistant material, a micaceous material, and/or a fiber composite material.

Here, a micaceous material is also considered a high temperature resistant material.

Examples of further high temperature resistant materials are the following:
high temperature glass wool (in particular AES (alkaline earth silicate wool));
aluminum silicate wool (ASW);
polycrystalline wool (PCW);
a material sold by ElringKlinger AG, Max-Eyth-Strasse 2, 72581 Dettingen, Germany, under the name “Elrotherm PRO”, said material comprising sebum, high temperature stone wool fibers, aluminum hydroxide, 4 percent by weight glass fibers, kaolin, acrylate, bentonite, silicon dioxide, silicic acid, vermiculite, and iron oxide-hydroxide;
a material sold by ElringKlinger AG, Max-Eyth-Strasse 2, 72581 Dettingen, Germany, under the name “Elrotherm ECO”, said material comprising sebum, high temperature stone wool fibers, aluminum hydroxide, 4 percent by weight glass fibers, kaolin, mica, acrylate, bentonite, diiron trioxide, silicon dioxide, iron oxide-hydroxide, cellulose, and basalt fiber.

Provision may further be made that the first layer and/or the second layer of the cover comprise(s) a sandwich material, which comprises a first top layer, a second top layer, and an intermediate layer arranged between the two top layers.

Here, the first top layer and/or the second top layer may be made, e.g., of aluminum or of an aluminum alloy.

If the sandwich material is arranged in the first layer of the cover and the first top layer faces toward the battery cells, the first top layer should be made of an electrically insulating material and/or be provided with an electrically insulating coating.

Such an electrically insulating coated may be made, e.g., of Al₂O₃, which is heat-resistant and electrically non-conductive.

The intermediate layer may be made of a micaceous material or of one of the other high temperature resistant materials stated above.

For example, provision may be made that the sandwich material contains a first top layer and a second top layer of aluminum or of an aluminum alloy and as an intermediate layer contains a layer of the high temperature resistant material with the name “Elrotherm PRO” or of the high temperature resistant material with the name “Elrotherm ECO”.

The first top layer and/or the second top layer of the sandwich material may be provided, e.g., with a hot-dip galvanization.

In particular, the first top layer and/or the second top layer of the sandwich material may be made of hot-dip galvanized aluminum alloy.

It is particularly favorable if the first layer and/or the second layer of the cover contain(s) a micaceous material, a high temperature resistant material, or a fiber composite material as a main component.

The material of the first layer and/or the material of the second layer may be provided with a coating, in particular with a hot-dip galvanization.

However, the side of the first layer of the cover that faces toward the battery cells should not be provided with an electrically conductive coating and thus not with a hot-dip galvanization.

Alternatively to a hot-dip galvanization, the material of the first layer and/or the material of the second layer may be provided with a coating of Al₂O₃, which is heat-resistant and electrically non-conductive.

The first layer of the cover serves primarily to prevent the ingress of particles from the defective battery cell into the interspace between the first layer and the second layer (outside of the penetration point).

The first layer therefore preferably has a higher mechanical strength than the second layer of the cover.

For example, provision may be made that the first layer of the cover contains a micaceous material as a main component.

Provision may further be made that the second layer of the cover contains a different high temperature resistant material than a micaceous material and/or a fiber composite material as a main component.

The at least one penetration device in the first layer of the cover preferably comprises at least one line of weakness.

Such a line of weakness can serve as a predetermined breaking point of the first layer of the cover in the case of a thermal fault.

It is particularly favorable if the at least one line of weakness of the penetration device is configured as a perforation line.

In one particular embodiment of the invention, provision is made that at least one line of weakness of at least one penetration device is of annularly closed configuration.

Here, such a line of weakness may be, in particular, of substantially circular configuration.

In the event of a thermal fault, the portion of the first layer enclosed by the line of weakness of annularly closed configuration is preferably separated out of the first layer along the line of weakness and moved by the hot gases away from the penetration point formed by said separation.

Alternatively or in addition hereto, provision may be made that at least one penetration device of the first layer comprises at least two lines of weakness, which intersect one another.

Due to the intersection of the lines of weakness, preferably substantially triangular portions of the first layer are created, which in the event of a thermal fault are separated from one another along the lines of weakness and under the pressure of the escaping hot gases are deformed into the interspace between the first layer and the second layer of the cover and out of the plane of the first layer.

In this case, as a result of this deformation of the portions of the first layer separated from one another by the lines of weakness, the penetration point is created through which hot gas from the battery cell is able to enter through the first layer into the interspace between the first layer and the second layer of the cover. However, in this case, there is no portion of the first layer that would be completely separated from the first layer and moved away from the penetration point.

The cover in accordance with the invention is suited, in particular, for use as a constituent part of a battery module or a battery store, which comprises a plurality of battery cells and at least one cover in accordance with the invention.

The cover may serve, in particular, as a lid of the battery module or the battery store.

In addition to the function of preventing a propagation of a thermal fault, the cover may also take on the function of a contact protection for the terminals of the battery cells and/or for the current taps of the battery module or the battery store.

In principle, the battery cells of the battery module or the battery store may be shaped in any way, for example as prismatic cells or as pouch cells.

In a particular embodiment of the invention, provision is made that the battery cells are configured as round cells.

Here, provision may be made, in particular, that the first layer and the second layer of the cover are oriented substantially perpendicularly to the longitudinal center axes of the battery cells configured as round cells.

Preferably each battery cell of the battery module or the battery store is associated with a respective penetration device in the first layer of the cover.

The number of penetration devices in the first layer of the cover preferably corresponds to the number of battery cells of the battery module or the batter bank.

The penetration device is preferably arranged over a degassing opening of the respective battery cell associated with the penetration device in a Z-direction of the battery module or the battery store that is oriented in parallel to the longitudinal center axes of the battery cells.

Due to the multilayer structure of the cover in accordance with the invention for a battery module or for a battery store, the thermal barrier between the battery cell space in which the battery cells of the battery module or the battery store are arranged and the outside space of the battery module or the battery store is enlarged.

In a normal operating state of the battery module or the battery store, the interspace between the first layer and the second layer of the cover is preferably filled with air.

The cover in accordance with the invention for a battery module or for a battery store serves, in particular, as a multilayer propagation protection for round cell battery modules or round cell battery stores.

The cover in accordance with the invention is preferably made of heat-resistant materials.

Further features and advantages of the invention are subject matter of the subsequent description and the graphical representation of exemplary embodiments.

### BRIEF DESCRIPTION OF THE DRAWINGS

FIG. 1 shows a schematic perspective depiction of a battery module, which comprises a housing with delimiting walls and a plurality of battery cells that are configured, e.g., as round cells, and comprises a cover, which comprises a first layer facing toward the battery cells in the mounted state of the cover and a second layer facing away from the battery cells in the mounted state of the cover, wherein the first layer comprises a respective penetration device for each battery cell, which penetration device enables a passage of hot gas from the respective battery cell through the first layer of the cover at a penetration point, and wherein the gas that has passed through the first layer is dissipated from the penetration point by an interspace between the first layer and the second layer;

FIG. 2 shows a perspective depiction corresponding to FIG. 1 of the battery module from FIG. 1 without the cover;

FIG. 3 shows a perspective depiction corresponding to FIG. 1 of the battery module without the second layer of the cover;

FIG. 4 shows an enlarged depiction of the region I from FIG. 3 in an initial state of the penetration device in which the penetration device closes the first layer of the cover;

FIG. 5 shows a depiction corresponding to FIG. 4 of the region I from FIG. 3 in a penetration state in which the penetration device has produced a penetration point that enables a passage of hot gas from a battery cell through the first layer of the cover into the interspace between the first layer and the second layer of the cover;

FIG. 6 shows a schematic depiction of a row of battery cells of the battery module from the from FIGS. 1 to 5 in a degassing state in which hot gas is escaping from one of the battery cells, but the first layer of the cover has not yet been penetrated;

FIG. 7 shows a schematic depiction corresponding to FIG. 6 of a row of battery cells of the battery module and the cover in a penetration state after a penetration point in the first layer of the cover has been opened and the hot gas escaping from the defective battery cell enters through the opened penetration point into the interspace between the first layer and the second layer of the cover and is dissipated away from the penetration point in the interspace between the first layer and the second layer of the cover;

FIG. 8 shows a schematic perspective depiction of the battery module from FIGS. 1 to 7 in the penetration state in which hot gas from a defective battery cell is entering through the penetration point into the interspace between the first layer and the second layer of the cover and is dissipated in directions oriented in parallel to the first layer and the second layer of the cover to end-face outlet openings of the cover in the interspace between the first layer and the second layer of the cover;

FIG. 9 shows a schematic perspective depiction corresponding to FIG. 4 of a penetration device of a second embodiment of a cover for a battery module in which the penetration device comprises two lines of weakness, in particular perforation lines that intersect one another, in an initial state of the penetration device in which the penetration device has not yet opened the penetration point; and

FIG. 10 shows a depiction corresponding to FIG. 9 of the penetration device of the second embodiment of a cover for a battery module, in a penetration state after the penetration point has been opened by the penetration device.

### DETAILED DESCRIPTION OF THE INVENTION

The same or functionally equivalent elements are provided with the same reference numerals in all Figures.

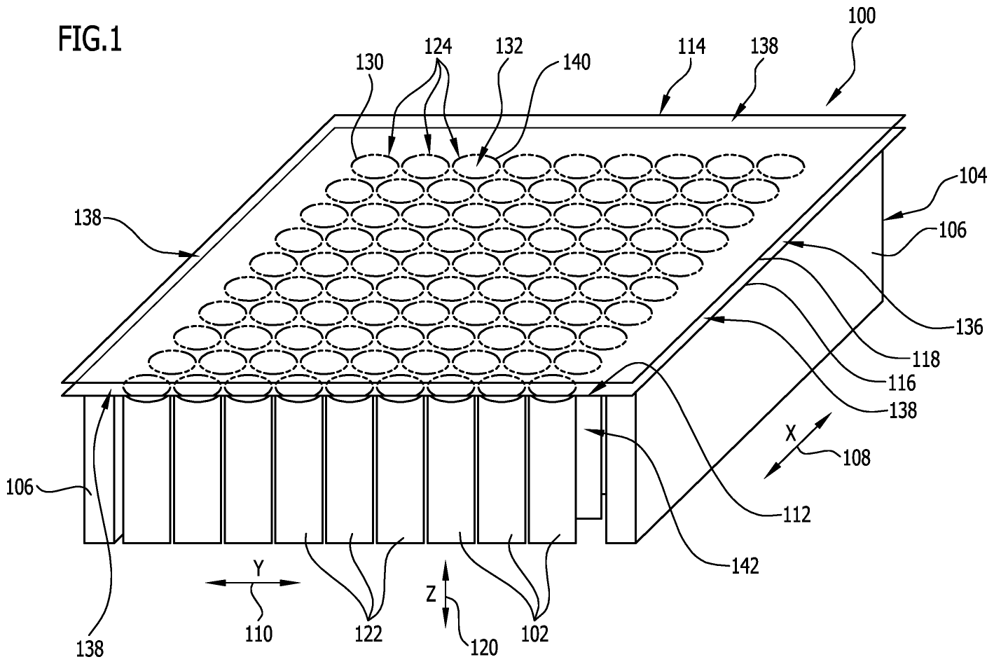

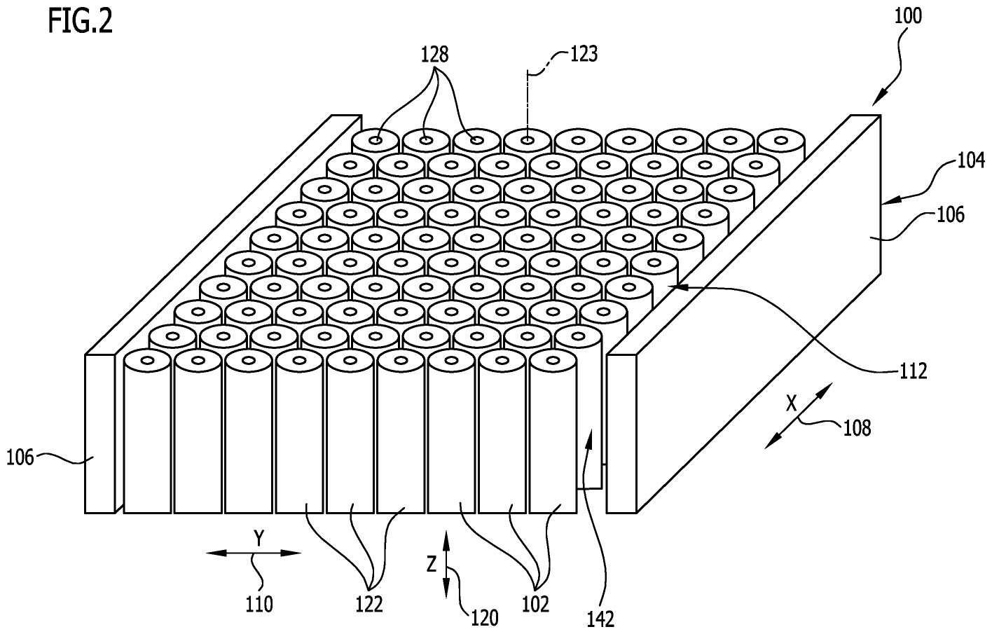

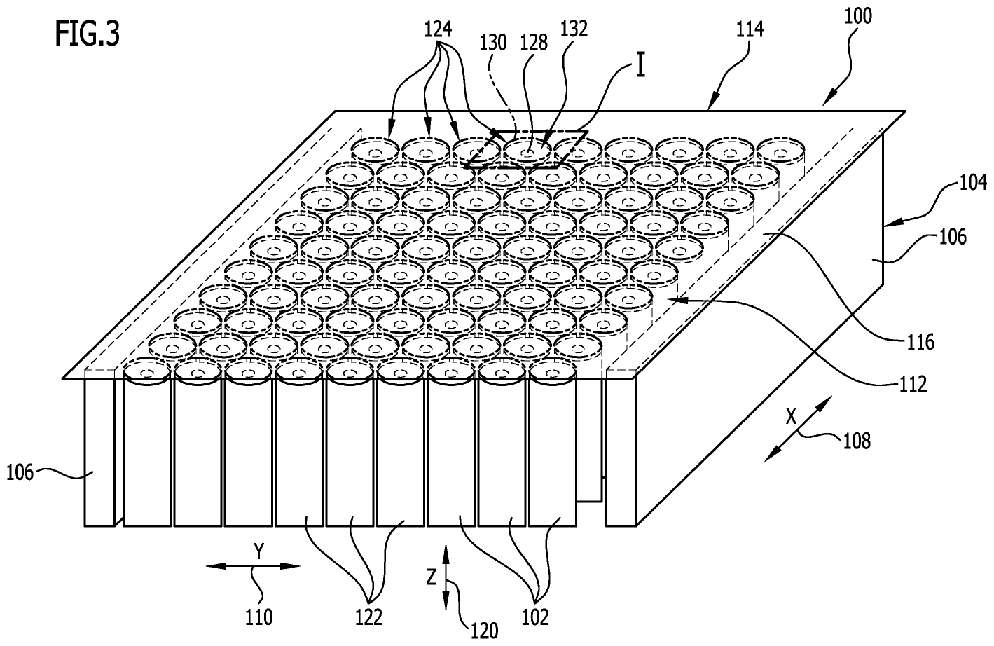

A battery module depicted in FIGS. 1 to 9 and denoted as a whole with 100 comprises a plurality of battery cells 102, which are arranged in a housing 104 of the battery module 100.

In addition, the housing 104 may also be a housing of a battery store, which may comprise a plurality of battery modules 100 without their own delimiting walls.

Only two delimiting walls 106 of the housing 104 are depicted in the drawings, which delimiting walls extend along a longitudinal direction 108 (X-direction) of the battery module 100 and are spaced at a distance from one another in a transverse direction 110 (Y-direction) of the battery module 100 oriented perpendicularly to the longitudinal direction 108.

Moreover, the housing 104 comprises a further pair of delimiting walls (not depicted), which extend along the transverse direction 110 (Y-direction) and connect together the two delimiting walls 106 that extend along the longitudinal direction 108 (X-direction).

The housing 104 further comprises another base wall (not depicted), which supports the battery cells 102.

The base wall and/or the lateral delimiting walls 106 may be a constituent part of a cooling device of the battery module 200 or of a battery store.

An outlet opening 112 of the housing 104 enclosed by the lateral delimiting walls 106 of the housing 104 is closed by means of a cover 114 of the battery module 100.

The cover 114 comprises a first layer 116 facing toward the battery cells 102 in the mounted state of the cover 114 and a second layer 118 facing away from the battery cells 102 in the mounted state of the cover 114.

Both the first layer 116 and the second layer 118 are of substantially planar configuration and each extend along a plane that is spanned by the longitudinal direction 108 (X-direction) of the battery module 100 and by the transverse direction 110 (Y-direction) of the battery module 100.

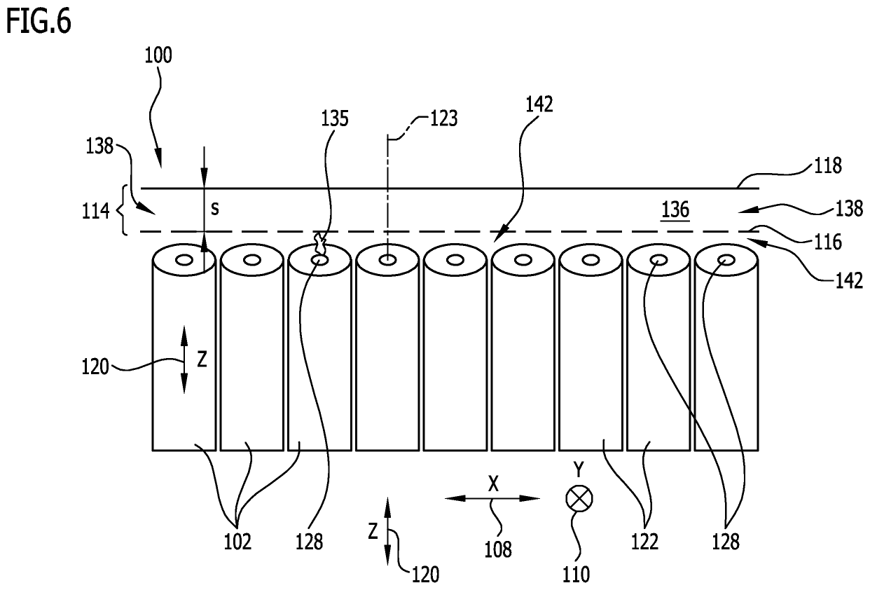

The first layer 116 and the second layer 118 are spaced at a distance s (see FIG. 6) from one another along a height direction 120 (Z-direction).

The height direction 120 of the battery module 100 is oriented perpendicularly to the longitudinal direction 108 (X-direction) and perpendicularly to the transverse direction 110 (Y-direction) of the battery module 100.

The battery cells 102 of the battery module 100 are configured as round cells 122 and thus have a substantially cylindrical form.

The cylindrical round cells 122 and, in particular, the longitudinal center axes 123 thereof extend in parallel to the height direction 120 (Z-direction) of the battery module 100.

The battery cells 102 of the battery module 100 are electrically connected to one another in a parallel and series connection by means of cell connectors (not depicted).

In particular, provision may be made that the battery cells 102 are connected in parallel to one another in groups of in each case n battery cells, m such groups of battery cells 102 then being connected in series. The total number of battery cells 102 of the battery module 100 is then n m.

The first layer 116 and the second layer 118 of the cover 114 of the battery module 100 are made of a heat-resistant material.

In this case, heat resistant means that the first layer 116 and the second layer 118 are able to withstand being subjected to hot gas that, in the case of a malfunction of one of the battery cells 102, escapes from the affected battery cell 102.

The heat-resistant material is preferably a high temperature resistant material that passes the Bunsen burner test.

The first layer 116 and the second layer 118 of the cover 114 are preferably made of a non-metallic material.

The first layer 116 and the second layer 118 of the cover may both be made of the same material or of different materials.

Provision is preferably made that the first layer 116 and/or the second layer 118 comprise(s) a micaceous material.

It is particularly favorable if the first layer 116 and/or the second layer 118 contain(s) a micaceous material as a main component.

The material of the first layer 116 and/or the material of the second layer 118 may be provided with a coating, for example with a hot-dip galvanization.

The material of the first layer 116 and/or the material of the second layer 118 may be a composite of a plurality of different materials.

In a preferred embodiment, provision is made that the first layer 116 and the second layer 118 are made of a micaceous material that may be coated.

The first layer 116 of the cover 114 is provided with penetration devices 124.

A respective penetration device 124 is preferably provided in the first layer 116 for each battery cell 102 of the battery module 100.

Each of the penetration devices 124 enables a passage of hot gas from the respectively associated battery cell 102 through the first layer 116 at a penetration point 126 when hot gas exits a degassing opening 126 in the case of a malfunction of the respective battery cell 102.

The escaping hot gas can be guided between the two layers 116 and 118, which together form a degassing channel, to a degassing element or to an opening at an end of the degassing channel.

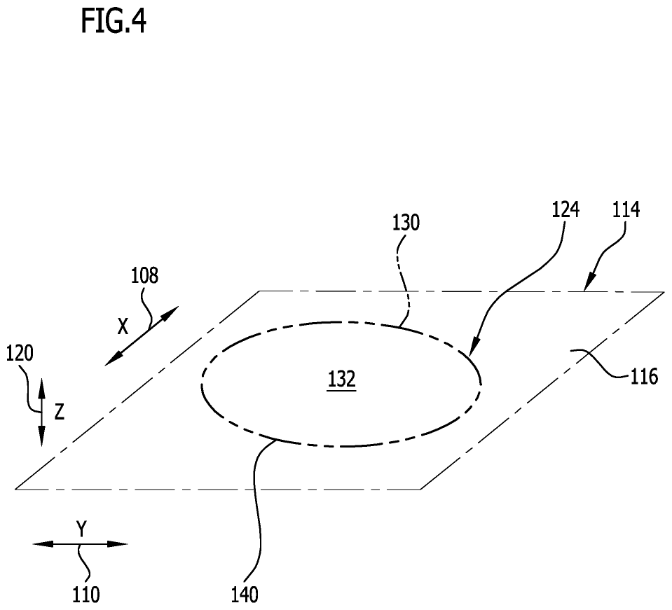

As can best be seen in FIG. 4, each of the penetration devices 124 comprises a respective line of weakness 130 along which the material of the first layer 116 of the cover 114 is weakened such that the line of weakness 130 forms a predetermined breaking point when subjected to hot gas from the degassing opening 128 of the respectively associated battery cells 102, along which predetermined breaking point a portion 132 of the first layer 116 surrounded by the line of weakness 130, when subjected to hot gas from the degassing opening 128, is separated out of the first layer in order to form the penetration point 126 for the passage of the hot gas through the first layer 116.

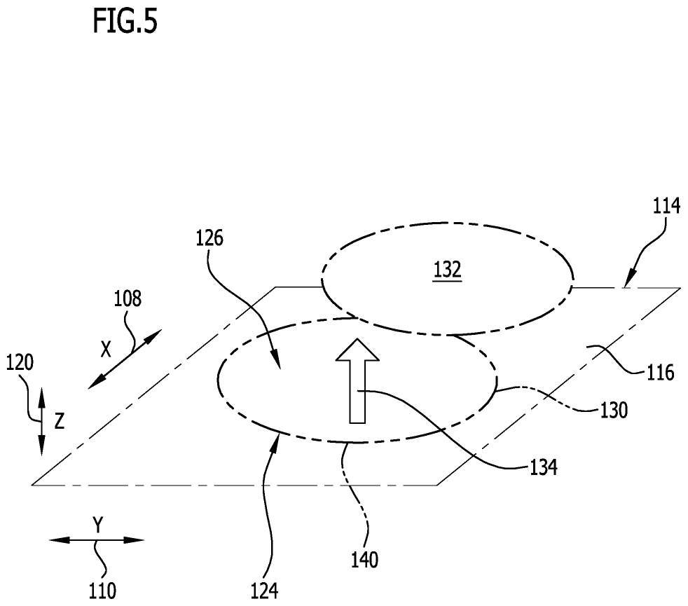

In FIG. 5, it is schematically depicted how, in the case of being subjected to hot gas from the degassing opening 128 of the respectively associated battery cell 102, said gas being illustrated by the arrow 134, the portion 132 of the first layer 116 is separated out of the first layer 116 along the line of weakness 130, the penetration point 126 thereby being formed by the penetration device 124.

The portion 132 of the first layer 116 that is separated out of the first layer 116 is moved away from the penetration point 126 by the hot gas that passes through the penetration point 126.

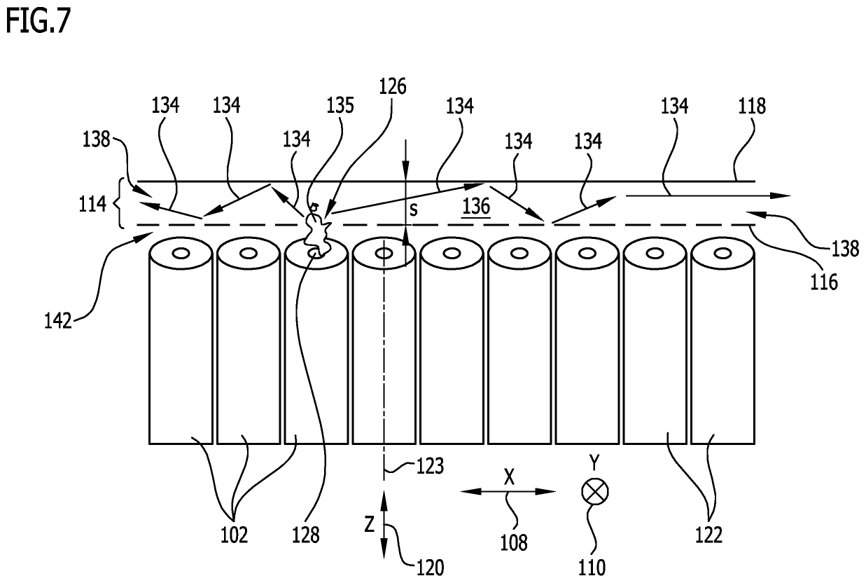

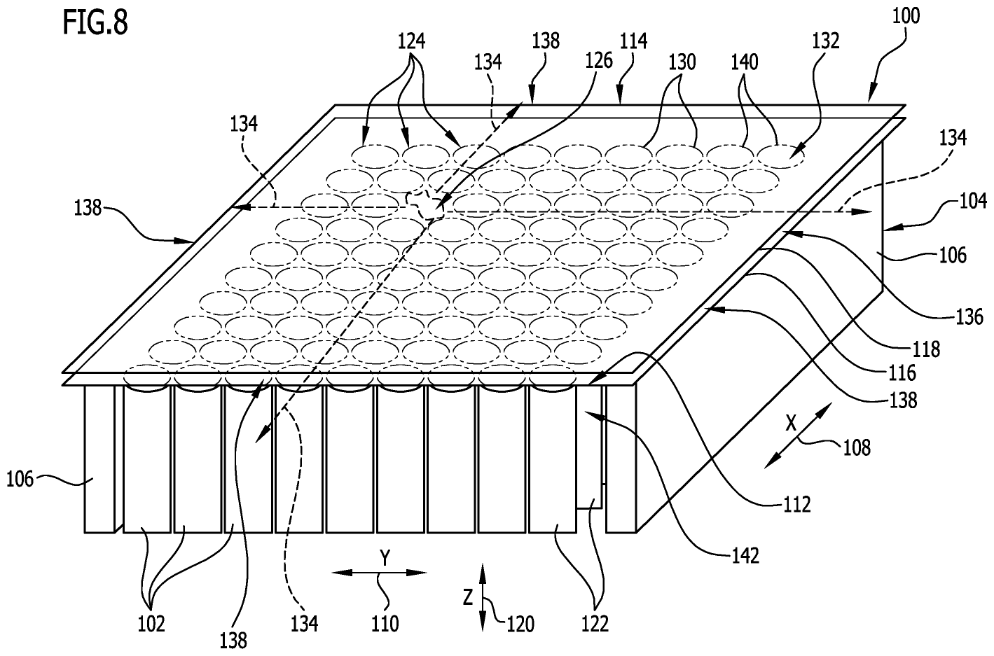

As can best be seen in FIG. 7, the hot gas that has entered through the penetration point 126 into the interspace 136 between the first layer 116 and the second layer 118 of the cover 114 after opening the penetration point 126 is dissipated through said interspace 136 to lateral outlet openings 138 of the interspace 136 (see FIG. 8), because the hot gas is only able to penetrate the first layer 116 at the penetration point 126 opened by the penetration device 124, but not the second layer 118 and not the first layer 116 at all other points except the penetration point 126.

Thus, the hot gas entering into the interspace 136 between the first layer 116 and the second layer 118 of the cover 114 at the penetration point 126 is reflected on the inner sides of the first layer 116 and the second layer 118 of the cover 114 that face toward one another until it exits the cover 114 through the lateral outlet openings 138.

Even flames 135 that may arise in the case of the thermal fault only burst through the penetration point 126 into the interspace 136 between the first layer and the second layer 118 of the cover 114, but not from there into the battery cell space 142 located under the first layer 116.

In this embodiment, the line of weakness 130 of the penetration device 124 is of annularly closed configuration.

In particular, provision may be made that the line of weakness 130 is of substantially circular configuration.

The line of weakness 130 may be configured, e.g., as a perforation line 140.

The material thickness of the first layer 116 is reduced at least in sections along such a perforation line 140.

Here, the material thickness of the first layer 116 along the perforation line 140 at one or more points may be reduced to zero in sections, such that a through-opening in the first layer 116 is formed at the respective points of the perforation line 140.

Provision is preferably made that the geometric center of gravity of the line of weakness 130 (the center of the circle in the case of a circular line of weakness 130) is arranged over the degassing opening 128 of one of the battery cells 102 along the height direction 120 (Z-direction) of the battery module 100.

The cover 114 described above serves as a propagation protection device for the battery module 100 in the case of failure of one of the battery cells 102 of the battery module 100, which propagation protection device prevents the propagation of a thermal failure of such a battery cell 102 to adjacent battery cells 102 of the battery module 100.

In the initial state, i.e. in a normal battery state of the battery module 100, the interspace 136 between the first layer 116 and the second layer 118 of the cover 114 is filled with air.

In the case of a thermal fault at one of the battery cells 102, hot gas exits the degassing opening 128 of the defective battery cell 102 and encounters the penetration device 124 associated with the battery cells 102 in the first layer 116 of the cover (see FIG. 6).

As a result of the penetration device 124 being subjected to the hot gas from the degassing opening 128 of the battery cell 102, the penetration device 124 is activated by the portion 132 of the first layer 116 being separated out of the first layer 116 along the line of weakness 130 and being moved out of its initial position, a penetration point 126 in the first layer 116 thereby being opened.

This opening of the penetration point 126 is brought about by the pressure of the hot gas exiting the degassing opening 128 of the battery cell 102.

The hot gas and, as the case may be, particles from the defective battery cell 102 then penetrate into the interspace 136 between the first layer 116 and the second layer 118 of the cover 114.

Due to the merely punctual penetration of the first layer 116 at the penetration point 126, other battery cells 102 of the battery module 100, in particular the further battery cells 102 directly adjacent to the defective battery cell 102, are protected from a blowback of the hot gases and/or flames from the interspace 136 between the first layer 116 and the second layer 118 of the cover 114 into the battery cell space 142 of the battery module 100 arranged on the side of the first layer 116 that faces away from the second layer 118 of the cover 114, whereby a propagation of the thermal fault from the defective battery cell 102 to other battery cells 102 of the battery module 100 is able to be prevented or at least hindered and/or slowed.

The hot gas and, as the case may be, flames 135 and particles entering the interspace 136 are dissipated to the lateral outlet openings 138 of the cover 114 by the interspace 136 between the first layer 116 and the second layer 118, which is impenetrable to the hot gas.

As a result, a degassing of the battery module 100 takes place through the interspace 136 between the first layer 116 and the second layer 118 of the cover 114 of the battery module 100.

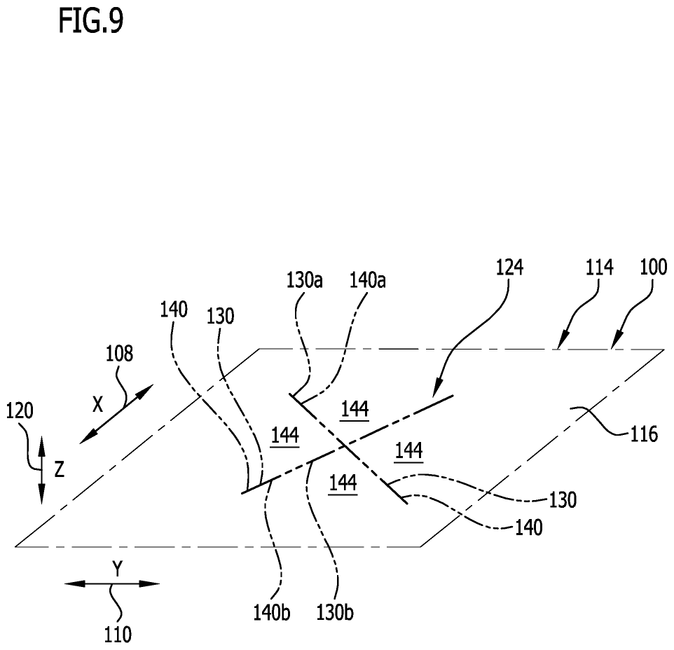

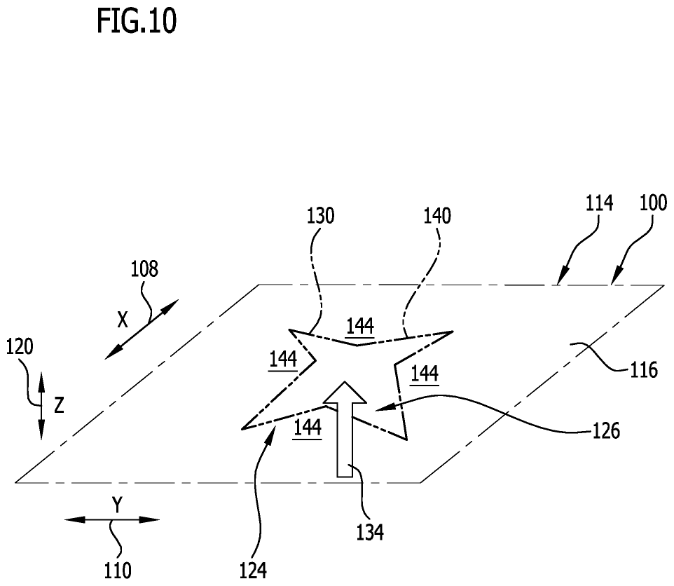

A second embodiment depicted in FIGS. 9 and 10 of a cover 114 for a battery module 100 differs from the first embodiment depicted in FIGS. 1 to 8 in that the penetration devices 124 each comprise no annularly closed line of weakness 130, but instead each comprise two intersecting lines of weakness 130a and 130b.

The lines of weakness 130a and 130b are preferably of substantially rectilinear configuration.

The lines of weakness 130a and 130b bound triangular portions 144 of the first layer 116.

When this penetration device 124, upon occurrence of a thermal fault at the battery cell 102 associated with this penetration device 124, is subjected to hot gas from the degassing opening 128 of the respective battery cell 102, the first layer 116 is separated along the lines of weakness 130a and 130b, which serve as predetermined breaking points of the first layer 116, and the portions 144 of the first layer 116 bound by the lines of weakness 130a, 130b are opened into the interspace 136 between the first layer 116 and the second layer 118 of the cover 114. In this case, too, this creates a penetration point 126 through which the hot gas from the degassing opening 128 of the defective battery cell 102 enters into the interspace 136 between the first layer 116 and the second layer 118 of the cover 114 and from there is dissipated through the interspace 136 to the lateral outlet openings 138 of the cover 114, as has already been described above in connection with the first embodiment depicted in FIGS. 1 to 8 of a cover 114 for a battery module 100.

In particular, the lines of weakness 130a, 130b may be configured as perforation lines 140a, 140b.

In all other respects, the second embodiment depicted in FIGS. 9 and 10 of a cover 114 for a battery module 100 corresponds with respect to structure, function, and production method with the first embodiment depicted in FIGS. 1 to 8, to the preceding description of which reference is made in this regard.

1. A cover for a battery module or for a battery store that comprises a plurality of battery cells,
wherein the cover comprises a first layer facing toward the battery cells in the mounted state of the cover and a second layer facing away from the battery cells in the mounted state of the cover,
wherein the first layer comprises at least one penetration device, which enables a passage of hot gas from a battery cell through the first layer at a penetration point, and
wherein the gas that has passed through the first layer is able to be dissipated from the penetration point in an interspace between the first layer and the second layer.

2. The cover in accordance with claim 1, wherein the second layer is impenetrable to hot gas that passes through the first layer at the penetration point.

3. The cover in accordance with claim 1, wherein at least one of i) the first layer and ii) the second layer comprise(s) a micaceous material.

4. The cover in accordance with claim 1, wherein at least one of i) the first layer and ii) the second layer comprise(s) at least one of i) a high temperature resistant material and ii) a fiber composite material.

5. The cover in accordance with claim 1, wherein the penetration device comprises at least one line of weakness.

6. The cover in accordance with claim 5, wherein the at least one line of weakness is configured as a perforation line.

7. The cover in accordance with claim 5, wherein at least one line of weakness is of annularly closed configuration.

8. The cover in accordance with claim 5, wherein at least two lines of weakness intersect one another.

9. A battery module or battery store, comprising a plurality of battery cells and at least one cover, said cover comprising a first layer facing toward the battery cells in the mounted state of the cover and a second layer facing away from the battery cells in the mounted state of the cover,
wherein the first layer comprises at least one penetration device, which enables a passage of hot gas from a battery cell through the first layer at a penetration point, and
wherein the gas that has passed through the first layer is able to be dissipated from the penetration point in an interspace between the first layer and the second layer.

10. The battery module or battery store in accordance with claim 9, wherein the battery cells are configured as round cells, as prismatic cells, or as pouch cells.

11. The battery module or battery store in accordance with claim 10, wherein the first layer and the second layer of the cover are oriented substantially perpendicularly to the longitudinal center axes of the battery cells.
